(19) United States
(12) Patent Application Publication
(10) Pub. No.: US 2021/0109048 A1
(43) Pub. Date: Apr. 15, 2021

(54) CALORIMETER

(71) Applicant: IKA - Werke GmbH & Co. KG, Staufen (DE)

(72) Inventor: Alf-Bernd Ambs, Waldkirch (DE)

(21) Appl. No.: 16/975,424

(22) PCT Filed: Feb. 25, 2019
(86) PCT No.: PCT/EP2019/054626

§ 371 Date: Nov. 10, 2020

(30) Foreign Application Priority Data
Feb. 26, 2018 (DE) 10 2018 104 327.9

(51) Int. Cl. G01N 25/26

(52) U.S. Cl. CPC G01N 25/26

(57) ABSTRACT

The invention relates to improvements in the technical field of calorimetry. Hereby, in particular, a calorimeter (1) is proposed, that exhibits a pressure vessel (2) that is provided with a strain gauge (8). This is with the aim of coming to a conclusion on the deformation of a pressure vessel (2) when conducting calorimetric measurements at least indirectly on the internal pressure in the pressure vessel (2).

### FIELD OF THE INVENTION

The invention relates to a calorimeter for determining the calorific value of a sample, wherein the calorimeter exhibits a pressure vessel and a decomposition vessel arranged in the pressure vessel for taking up the sample.

### BACKGROUND OF THE INVENTION

Such calorimeters are previously known from the prior art and in practice in various embodiments. Calorimeters are used to determine the calorific value of a sample. Thereby in an inherently known way, a sample is ignited by means of an ignition device of the calorimeter inside the decomposition vessel. To do this, firstly the sample is introduced into the decomposition vessel and then an oxygen atmosphere is generated inside the decomposition vessel. By activating the ignition device, the sample is then combusted inside the decomposition vessel.

The heat thus produced is dissipated through the decomposition vessel to a liquid, generally water, with which the pressure vessel is filled and which surrounds the decomposition vessel. Knowing the quantity of liquid, the thermal capacity and the temperature that the liquid in the pressure vessel obtains by combusting the sample in the decomposition vessel, the calorific value of the sample can be determined.

To avoid the pressure vessel failing, the pressure vessels are generally tested to a set number of calorimetric measurement processes and replaced as required, for example, if damage is established. So, for example, there are calorimeters in which the pressure vessel has been tested for one thousand calorimetric measurement processes for safety reasons, and must be replaced accordingly. This can have a negative effect on handling the calorimeter.

### SUMMARY OF THE INVENTION

The task of the invention is, therefore, to provide a calorimeter of the type described in the preamble, the handling of which is simplified and that allows testing as required and accordingly replacement of the pressure vessel as required.

This task is solved with a calorimeter of the type mentioned in the preamble by the means and characteristics of the independent claim directed to such a calorimeter. In particular, to solve this task it is proposed that the calorimeter exhibits a strain gauge that is arranged at least indirectly on the pressure vessel, and with which a pressure-related deformation of the pressure vessel can be determined. Preferably, with the at least one strain gauge, as well as pressure-related deformation of the pressure vessel at least indirectly, also a pressure inside the pressure vessel can be determined.

In this way, the pressure vessel can be monitored during a calorimetric measurement. Due to a pressure-related deformation of the pressure vessel, at least indirectly a conclusion can be made as to the pressure in the pressure vessel. As soon as a maximum permissible pressure and/or a maximum permissible deformation of the vessel has been exceeded, in which damage to the pressure vessel is to be suspected, it can be established that continued usage of the pressure vessel on the calorimeter is not permitted and testing and, as appropriate, replacement of the pressure vessel, is required.

In this very context it may be sensible, if the calorimeter exhibits a shutdown device that prevents a usage and/or continued usage of the calorimeter and, in particular, of the pressure vessel where, particularly with the at least one strain gauge, overload of the pressure vessel has been established and/or when exceeding a pressure limit and/or where there is established impermissible deformation of the pressure vessel. This shutdown device may be connected to at least one strain gauge and output a blocking signal depending on a corresponding signal from the at least one strain gauge that, for example, suppresses further ignition of an ignition device of the calorimeter. The shutdown device may be part of a control unit of a calorimeter or connected to a control unit of a calorimeter by signal technology.

As soon as a pressure vessel that has been overloaded, due to its high pressure or due to an impermissible deformation, is detected, it is possible to prevent continued operation of the calorimeter with the overloaded pressure vessel using the shutdown device and/or the control unit of the calorimeter.

A particular advantage of the calorimeter according to the invention consists of the fact that, with the aid of the at least one strain gauge, without great expense, even a plastic deformation of the pressure vessel can be established. As soon as a plastic deformation of a pressure vessel is established using the at least one strain gauge, it can be established that the plastically-deformed pressure vessel is no longer suitable for continued usage in further calorimetric measurements. Beforehand such a plastically-deformed pressure vessel must first be checked at least for its continued load capacity and even replaced, as appropriate.

All in all, the calorimeter according to the invention therefore provides the possibility of testing and, as appropriate, replacing pressure vessels as required, and not already after a determined number of calorimetric measurement processes, although an actual overloading of the pressure vessel has not yet occurred.

Hereby, the calorimeter according to the invention, due to the at least one strain gauge, has the advantage that not yet once does an actual pressure limit, that must not be exceeded, have to be specified. As soon as an impermissible deformation, for example, a plastic deformation of the pressure vessel, has been established using the at least one strain gauge, the pressure vessel must be checked and replaced, as appropriate.

Hereby, for example, the already previously mentioned shutdown device and/or a control unit of the calorimeter can suppress continued operation of the calorimeter with the impermissible or even permanently-deformed pressure vessel.

In a particularly advantageous embodiment, the at least one strain gauge for determining the pressure may be arranged on an outer side of the pressure vessel facing away from the decomposition vessel. In this way, the strain gauge does not come into direct contact with the liquid the pressure vessel is filled with when the calorimeter is in operation and, therefore, does not have to be protected to a considerable degree from the effect of the liquid.

The at least one strain gauge used to determine a deformation of the pressure vessel and at least for indirect determination of the pressure may preferably be arranged directly on the pressure vessel. Therefore, a pressure-related deformation of the pressure vessel can be transferred particularly simply and reliably to the at least one strain gauge. However, it is also possible that the strain gauge is arranged not directly on the pressure vessel but rather on a bracket that is connected to the pressure vessel in such a way that a mechanical stress of the bracket, that is caused by a mechanical and pressure-related loading of the pressure vessel, can be transferred to the at least one strain gauge for determining the pressure. Such a bracket may, for example, be a holding plate.

It may be advantageous if the at least one strain gauge is arranged at a place on the pressure vessel, at which it preferably experiences a pressure-related loading and/or deformation. However, the at least one strain gauge can be arranged, particularly well protected, on an outer underside of the pressure vessel. Here, it can be arranged as close as possible to, for example, a control unit and/or a shutdown device of the calorimeter. It is also possible to accommodate the at least one strain gauge on the underside of the pressure vessel in a housing of the calorimeter that may also surround the underside of the pressure vessel. Therefore, the at least one strain gauge can be well protected from external effects which can minimise the risk of it being damaged.

The calorimeter may furthermore exhibit a measuring circuit that is set up for compensation of a temperature error of the at least one strain gauge, that is used to determine a deformation of the pressure vessel and for indirectly determining the pressure. By heating the at least one strain gauge, which may occur with a calorimetric measurement, the at least one strain gauge may be subjected to a temperature error, that may falsify a correct determination of the deformation of the pressure vessel and/or the pressure inside the pressure vessel. This measurement circuit for temperature compensation may be formed as a Wheatstone bridge circuit. The measurement circuit, in addition to the at least one strain gauge used to determine the deformation of the pressure vessel and at least one indirect pressure determination may exhibit at least one further strain gauge. This at least one further strain gauge may be designated as a temperature compensation strain gauge.

In this, the at least one temperature compensation strain gauge is preferably connected to the pressure vessel in such a way that makes a heat transfer from the pressure vessel to the at least one temperature compensation strain gauge without the at least one temperature compensation strain gauge experiencing a pressure-related load and/or change of length due to its contact with the pressure vessel.

The measurement circuit may be formed in such a way that, due to the arrangement of the total of at least two strain gauges in the measurement circuit, it outputs a value as a measurement result that only represents the pressure inside the pressure vessel and/or a deformation of the pressure vessel entailed by this pressure.

Particularly simply, the previously-mentioned measurement circuit can realise, if the at least one strain gauge used for determining the deformation of the pressure vessel and/or for determining the pressure and the at least one second strain gauge or temperature compensation strain gauge of the measurement circuit are identical strain gauges.

As well as mechanical stress invoked by the pressure change inside the pressure vessel and that acts on the at least one strain gauge provided to determine the deformation of the pressure vessel and/or determine the pressure, this first strain gauge due to the heating that must occur, is subjected to a temperature error that can be designated as temperature-related drift of the strain gauge. This temperature error may be due to a temperature-related change of the electrical resistance and/or a length of the strain gauge. This is particularly the case if the strain gauge is an electrical or electronic strain gauge. Fundamentally, the usage of optical strain gauges as at least one strain gauge for determining a deformation of the pressure vessel and/or to determine the pressure is also conceivable.

Through the at least one second strain gauge used for temperature compensation and preferably identical, in heat transmission contact with the pressure vessel, although not arranged on the pressure vessel, so that also mechanical stress when the pressure inside the pressure vessel rises is transferred to the second strain gauge, the temperature error of the measurement determined by the first strain gauge can be compensated for. This is particularly simply possible if the entire at least two strain gauges are identical strain gauges.

The measurement circuit may be formed as a bridge circuit, in which both strain gauges are integrated. Preferably, the measurement circuit is formed in such a way that the compensation of the temperature error of the at least one strain gauge provided for determining the pressure occurs automatically and from a measurement value output from the measurement circuit the mechanical stress of the pressure vessel and the pressure inside the pressure vessel can be directly concluded.

To ensure a heat transfer to the at least one second strain gauge or temperature compensation strain gauge, it may be particularly advantageous if the pressure vessel is made of a particularly thermally-conductive material, for example of aluminium.

To determine the quantity of heat dissipated from the sample when it is combusted, the calorimeter may exhibit at least one temperature sensor inside the pressure vessel.

Furthermore, it is possible that the calorimeter exhibits a control unit. This control unit may be connected by signal technology to the already previously-mentioned shutdown device and/or exhibit such a device. The control unit may be formed in such a way that it suppresses an operation of the calorimeter where, detected with at least one strain gauge and/or with the measurement circuit, an impermissible, for example, plastic, deformation of the pressure vessel is present.

To fill the pressure vessel with liquid, particularly with water, the pressure vessel may exhibit an infeed. In may be particularly advantageous if the pressure vessel also exhibits an overrun, in which a liquid sensor is arranged. In this way it is possible to fill the pressure vessel with liquid through the infeed. This happens at least as long as until the liquid sensor in the overrun of the pressure vessel comes into contact with liquid. As soon as the liquid sensor in the overrun of the pressure vessel detects liquid, a complete filling of the pressure vessel with liquid is presumed.

A complete filling of the pressure vessel with liquid is advantageous, on the one hand, for a precise calorimetric measurement and, on the other hand, for safety reasons. If a residual quantity of air or gas is located inside the pressure vessel, less liquid is located in the pressure vessel than with a completely-filled pressure vessel. The smaller quantity of liquid in the only partially-filled pressure vessel has an overall lower thermal capacity. If this is not considered in the calorimetric measurement, a precise determination of the calorific value of the sample combusted in the decomposition vessel does not occur.

Due to the possible pressure increase with a calorimetric measurement inside the pressure vessel and a compressibility of air in the pressure vessel, when the pressure vessel is emptied, hydraulic shock may also occur. On the one hand, this may affect the comfortable handling of the calorimeter and, on the other hand, also represent a safety risk.

It may be advantageous if the calorimeter exhibits an information output device, particularly a display device, through which information in relation to a calorimetric measurement and/or a state of the calorimeter, particularly its pressure vessel, can be output. Through this information output device, for example, audible and/or visual information in relation to a pressure value determined with the at least one strain gauge and/or with the measurement circuit, a temperature value of the liquid in the pressure vessel, a deformation of the pressure vessel, a proper filling of the pressure vessel of the calorimeter and/or a calorific value of a sample determined are displayed.

A particular aspect in the usage of a strain gauge as indirect pressure sensor on the pressure vessel may be seen in that with a plastic deformation of the pressure vessel, therefore, with a deformation, that remains when the pressure has dropped, due to the mechanical stress of the strain gauge coinciding with the plastic deformation, it continues to output a corresponding signal.

Inasmuch, no pressure limit has to be determined, the exceeding of which would make replacement or at least checking the pressure vessel necessary. Rather, as appropriate, pressure maxima over time that although they exceed a potential limit, still do not cause a plastic deformation of the pressure vessel may be tolerated. Inasmuch, the calorimeter according to the invention, compared with the calorimeters previously known from the prior art and practice allow an actual testing as required and also, as appropriate, a replacement as required of the pressure vessel, in the event that this would be overloaded due to a pressure increase with a calorimetric measurement.

The usage of at least one strain gauge provided to determine the pressure on the pressure vessel has a further advantage in the interaction with the temperature sensor of the calorimeter. By igniting and combusting the sample inside the decomposition vessel, a pressure rise inside the pressure vessel is caused. With the calorimeter functioning properly, therefore, in particular, if a stirring drive of the calorimeter is functioning properly, shortly after the pressure increase, a rise of temperature of the liquid inside the pressure container is to be anticipated. The pressure increases and therefore the successful ignition of the sample may, in any case, be detected with the aid of at least one strain gauge provided on the pressure vessel to determine the pressure. If then, after a determined period, there is no increase in temperature inside the pressure vessel, this may indicate a malfunction or incorrect operation of the calorimeter and here, in particular, a circulating device of the calorimeter may comprise a stirring device or magnetic stirrer with a stirring magnet.

If the circulation of the liquid inside the pressure vessel does not occur properly, a temperature rise is only set on the temperature sensor late or not at all, although with the aid of at least one strain gauge, used to determined pressure, the ignition can be proven undoubtedly.

The calorimeter according to the invention has a further advantage: Often, the decomposition vessel is only loosely enclosed, for example, by a sleeve-type hood that is put onto a baseplate of the decomposition vessel. If the decomposition vessel is not properly enclosed, part of the oxygen atmosphere directed into the decomposition vessel before igniting the sample may get out of the decomposition vessel into the pressure vessel. This can cause a pressure increase. Before combusting the sample, the decomposition vessel may be filled with the oxygen atmosphere under pressure, for example, with a pressure of 30×10⁵ Pa. If part of the oxygen atmosphere seeps from the decomposition vessel into the pressure vessel, this seepage may be determined with the aid of the strain gauge at least indirectly. After a calorimetric measurement has been made, the overpressure still in the decomposition vessel may be released by letting out the atmosphere contained in the decomposition vessel to ambient pressure. If, with the aid of the strain gauge on the pressure vessel, after releasing the overpressure from the decomposition vessel, a pressure can still be established that is above ambient temperature, it is suspected that previously a part of the oxygen atmosphere has got out of the decomposition vessel and into the pressure vessel. Depending on how high this determined overpressure then still is, the pressure vessel of the calorimeter must not be opened by an operator themselves, but only by the entrusted service partner.

The core aspect of the calorimeter according to the invention can be summarised as follows: The invention relates to improvements in the technical field of calorimetry. Hereby, the calorimeter according to the invention is proposed, that exhibits the pressure vessel that is provided with at least one strain gauge. This is with the aim of determining a deformation of the pressure vessel when conducting calorimetric measurements. This enables a load of the pressure vessel to be monitored and furthermore at least one internal pressure in the pressure vessel to be determined indirectly.

### BRIEF DESCRIPTION OF THE DRAWING

Using the drawing, an illustrative example of the invention is described in more detail below. The single FIGURE shows highly diagrammatically a cross-sectional illustration of a calorimeter with a two-part pressure vessel and a decomposition vessel arranged therein, in which a sample may be combusted under an oxygen atmosphere.

### DETAILED DESCRIPTION OF THE INVENTION

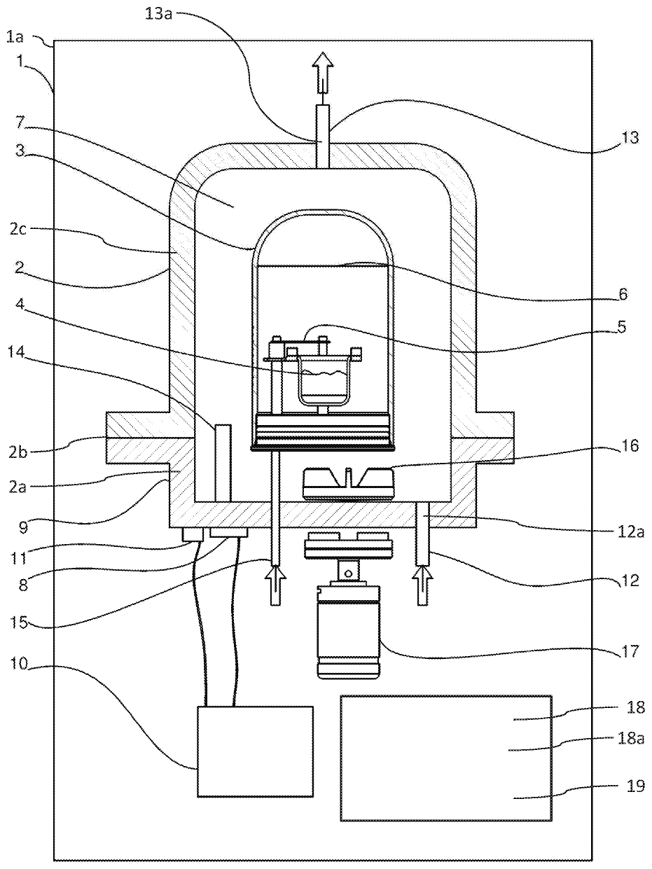

FIG. 1 shows a calorimeter designated as a whole with 1 for determining the calorific value of a sample 4. The calorimeter 1 exhibits a pressure vessel 2 and a decomposition vessel 3 arranged in the pressure vessel 2. The decomposition vessel 3 is used to take up the sample 4 to be combusted.

To combust the sample 4, the decomposition vessel 3 is filled with oxygen, which forms an oxygen atmosphere 6 in the decomposition vessel 3. This oxygen atmosphere 6 may exhibit an overpressure of, for example, 30 bar, compared with the ambient pressure. Then the sample 4 is ignited with the aid of the ignition device 5. The heat thus arising is passed onto a liquid via the decomposition vessel 3, that is to a water bath 7, inside the pressure vessel 2. Heating of the water bath 7 is measured and the calorific value of the probe 4 is determined from it.

The calorimeter 1 exhibits a strain gauge 8 that is arranged on the pressure vessel 2 and with which a pressure-related deformation of the pressure vessel 2 and therefore indirectly a pressure inside the pressure vessel 2 can be determined.

The FIGURE shows clearly that the strain gauge 8 is arranged on an outer side 9 of the pressure vessel 2. The outer side 9 of the pressure vessel 2 is therefore that side of the pressure vessel 2 that is facing away from the decomposition vessel 3 inside the pressure vessel 2. The strain gauge 8 is to be arranged directly on the outer side 9 of the pressure vessel 2 and in the present illustrative example also on a lower part 2a of the pressure vessel 2 in such a way that a pressure-related change of shape of the pressure vessel 2 can be transferred directly to the strain gauge 8. The lower part 2a of the pressure vessel 2 is connected via a flange 2b to the upper part 2c of the pressure vessel 2 such that it is pressure-tight.

On one underside of the lower part 2a of the pressure vessel 2, the strain gauge 8 is well protected and inside a housing 1a, indicated only highly diagrammatically, of the calorimeter 1.

The calorimeter 1 exhibits a measurement circuit 10 that is part of a pressure measurement system. With the aid of the measurement circuit 10, a temperature error of the strain gauge 8 used to determine a change of shape of the pressure vessel 2 and therefore to determine the pressure may be compensated for.

The measurement circuit 10 comprises the strain gauge 8 provided to determine the pressure and a second strain gauge 11 that may be used for a compensation of the temperature error and may therefore also be designated as temperature compensation strain gauge 11. The second strain gauge 11 is therefore connected to the pressure vessel 2 in such a way that a heat transfer from the pressure vessel 2 to this second strain gauge 11 occurs, without the second strain gauge 11 experiencing a pressure-related loading and/or change of length.

The measurement circuit 10 is set up to output a measured value representing the pressure in the pressure vessel 2. Both strain gauges 8 and 11 are identical strain gauges, so that the heat-related change of properties of the strain gauge 8 and a potentially therefore associated falsification of the pressure measurement determined by it can be particularly simply compensated for by the identically-reacting strain gauge 11 and its heat-related change considered in isolation.

To ensure a transfer of the temperature from the pressure vessel 2 to the second strain gauge 11, the pressure vessel 2 is manufactured from a good thermally-conducting material, e.g. of aluminium. The aim in the design of the pressure vessel 2 is that both strain gauges 8 and 11 in the measurement circuit 10 that must be arranged at different locations are heated in the same way. Hereby, it has proven to be advantageous if the pressure vessel 2 is made of good thermally-conducting material, e.g. of aluminium. Therefore, a homogeneous heating of both different locations at which both strain gauges 8 and 11 are arranged can be achieved. This may favour an accuracy of the temperature compensation in the determination of the deformation of the pressure vessel 2 and/or in the pressure determination of the pressure in the pressure vessel 2 by using the strain gauge 8.

Furthermore, the calorimeter 1 exhibits a temperature sensor 14 arranged inside the pressure vessel 2. With the aid of this temperature sensor 14, the heating of the water bath 7 inside the pressure vessel 2 when combusting the sample 4 may be measured and the calorimetric measurement conducted.

The measurement circuit 10 of the calorimeter 1 may be connected to a control unit 18 of the calorimeter 1 in such a way that the control unit 18 suppresses an operation of the calorimeter 1 when there is a plastic deformation of the pressure vessel 2 detected with the at least one strain gauge 8 and/or with the measurement circuit 10. For this purpose, the control unit 18 comprises a shutdown device 18a, that deactivates the calorimeter 1 with detected overload of the pressure vessel 2 and suppresses continued usage of the calorimeter 1 with the same pressure vessel 2.

The pressure vessel 2 of the calorimeter 1 exhibits an infeed 12. Through this infeed 12, the pressure vessel 2 is filled with liquid, here with the water bath 7. Through an overrun 13 that is provided on the end of the pressure vessel 2 opposite the infeed 12, the liquid the pressure vessel 2 is filled with when the pressure vessel 2 is filled completely seeps out again.

In the overrun 13, a liquid sensor 13a is arranged. In the infeed 12, a further liquid sensor 12a is provided. With the aid of both liquid sensors 12a and 13a, it may be established when filling of the pressure vessel 2 with liquid begins. As soon as the liquid sensor 12a arranged in the infeed 12 comes into contact with the liquid, it emits a corresponding signal. This may, for example, be processed by the control unit 18 already mentioned previously. The pressure vessel 2 continues to be filled with liquid. This is continued until the liquid sensor 13a arranged in the overrun 13 of the pressure vessel 2 comes into contact with the liquid and also emits a corresponding signal that can be processed by the control unit 18 of the calorimeter 1 accordingly. As soon as the second liquid sensor 13a in the overrun 13 of the pressure vessel 2 comes into contact with liquid, a proper and it can be concluded that the calorimeter 1 has been properly filled with liquid.

The calorimeter 1 also exhibits an information output device 19. This may be formed as an optical display device and/or as an audible signal device. Through this information output device 19, for example, a pressure value determined with the strain gauge 8 and/or with the measurement circuit 10, a temperature value and/or a proper filling of the pressure vessel 2 may be output to a user. The output of other information which may be of interest to the user of the calorimeter 1 is, of course, also possible.

Through an oxygen filling device 15, that is illustrated highly diagrammatically here only as an infeed and drain pipe, the decomposition vessel 3 may be filled with oxygen for producing the oxygen atmosphere 6. For example, this happens with a pressure of 30×10⁵ Pa. As soon as the pressure vessel 2 is completely filled with liquid, particularly with water, and the decomposition vessel 3 is filled with the oxygen atmosphere 6, the sample 4 is set on fire using the ignition device 5.

To distribute the heat dissipated from the sample 4 through the decomposition vessel 3 to the water bath 7 in the pressure vessel 2 into the water bath as uniformly and quickly as possible, and therefore distribute it inside the pressure vessel 2, the calorimeter 1 is equipped with a stirring device. This stirring device comprises a stirring drive 17 provided outside the pressure vessel 2. A stirring element 16 connected magnetically to the mixing drive 17 is arranged inside the pressure vessel 2 and, when the stirring device 17 is in operation, provides for a corresponding circulation of the water bath 7 and therefore for as homogeneous as possible a distribution of the heat inside the pressure vessel 2. Through the temperature sensor 14, the heat dissipated from the sample 4 when it is combusted and the associated increase in temperature of the water bath 7 can be determined and the calorimetric measurement is conducted.

With the aid of the measurement circuit 10 and both strain gauges 8 and 11 at least indirectly a corresponding pressure increase can be established, that indicates a proper ignition of the sample 4 inside the decomposition vessel 3. However, if a temperature increase in the water bath 7 that must be detected with the aid of the temperature sensor 14 does not happen, this may indicate that the stirring device 17 is not functioning properly or even that the magnetically-connected stirring element 16 has not been properly inserted inside the pressure vessel 2, therefore the circulation of the water bath 7 does not occur as provided.

With the aid of the strain gauge 8 or even with the aid of the measurement circuit 10, after releasing the atmosphere from the decomposition vessel 3 a pressure, that is greater than the ambient pressure, acting on the pressure vessel 2 is still detected, this also means a malfunction of the calorimeter 1. It is possible, in this case that, for example, the decomposition vessel 3 was not properly closed when it was filled with oxygen atmosphere 6 through the oxygen filling device 15 and possibly oxygen from the decomposition vessel 3 has got inside the pressure vessel 2. If the pressure in the pressure vessel 2 is too high, the calorimeter 1 emits, through its information output device 19, corresponding information to a user that the pressure vessel 2 must not or is not allowed to be opened due to the overpressure still present. Corresponding information may be output through the information output device 19 if, with the aid of the measuring circuit 10 and, in particular, the strain gauge 8, a plastic deformation of the pressure vessel 2 was able to be established. Then the pressure vessel 2 must be tested and replaced, as appropriate.

The invention relates to improvements in the technical field of calorimetry. Hereby, in particular a calorimeter 1 is proposed, that exhibits a pressure vessel 2 that is provided with at least one strain gauge 8. This is with the aim of measuring a deformation of the pressure vessel 2 when conducting calorimetric measurements and therefore conclude the internal pressure inside the pressure vessel 2 at least indirectly.

1. Calorimeter (1) for determining the calorific value of a sample (4), wherein the calorimeter (1) exhibits a pressure vessel (2) and a decomposition vessel (3) arranged in the pressure vessel (2) to take up a sample (4), wherein the calorimeter (1) includes at least one strain gauge (8) that is arranged relative to the pressure vessel (2) so as to determine a pressure-related deformation of the pressure vessel (2).

2.-12. (canceled)

13. The calorimeter (1) according to claim 1, wherein the calorimeter (1) includes a shutdown device (18a), that prevents the usage of the pressure vessel (2), with the at least one strain gauge (8) determining that a pressure limit has been exceeded.

14. The calorimeter (1) according to claim 1, wherein the at least one strain gauge (8) is arranged on an outer side (9) of the pressure vessel (2) facing away from the decomposition vessel (3).

15. The calorimeter (1) according to claim 1, wherein that the at least one strain gauge (8) is arranged directly on the pressure vessel (2).

16. The calorimeter (1) according to claim 1, wherein that the calorimeter (1) includes a measurement circuit (10) with which a temperature error of the at least one strain gauge (8) is able to be compensated for.

17. The calorimeter (1) according to claim 16, wherein that the measurement circuit (10) includes at least one second strain gauge (11), and wherein the at least one second strain gauge (11) is connected to the pressure vessel (2) in such a way that a heat transfer from the pressure vessel (2) to the at least one second strain gauge (11) occurs without the at least one second strain gauge (11) experiencing pressure-related stress and/or change of length.

18. The calorimeter (1) according to claim 16, wherein the measurement circuit (10) is set up to output a measured value that represents the pressure in the pressure vessel (2).

19. The calorimeter (1) according to claim 1, wherein the pressure vessel (2) is made of a good thermally conductive material.

20. The calorimeter (1) according to claim 1, wherein the calorimeter (1) includes at least one temperature sensor (14) arranged inside the pressure vessel (2).

21. The calorimeter (1) according to claim 1, wherein the calorimeter (1) includes a control unit (18) that suppresses an operation of the calorimeter (1) where there is an impermissible deformation of the pressure vessel (2) detected with the at least one strain gauge (8).

22. The calorimeter (1) according to claim 1, wherein the pressure vessel (2) includes an infeed (12) through which the pressure vessel (2) can be filled with liquid.

23. The calorimeter (1) according to claim 1, wherein the calorimeter (1) includes an information output device (19) through which information relating to a state of the pressure vessel (2), can be output.

24. The calorimeter (1) according to claim 1, wherein the calorimeter (1) includes a shutdown device (18a), that prevents usage of the pressure vessel (2), with the at least one strain gauge (8) determining that the pressure vessel (2) has been impermissibly deformed.

25. The calorimeter (1) according to claim 1, wherein the at least one strain gauge (8) is arranged on a bracket arranged on the pressure vessel (2).

26. The calorimeter (1) according to claim 17, wherein the at least one second strain gauge (11) is a temperature compensation strain guage.

27. The calorimeter (1) according to claim 19, wherein the good thermally conductive material is aluminum.

28. The calorimeter (1) according to claim 22, wherein the pressure vessel (2) includes an overrun (13) with a liquid sensor (13a).

29. The calorimeter (1) according to claim 22, wherein the infeed (13) includes a liquid sensor (12a).

30. The calorimeter (1) according to claim 23, wherein the information output device (19) includes a display.

31. The calorimeter (1) according to claim 23, wherein the information output device (19) is configured to output information relating to calorimetric measurements.
